(19) United States
(12) Patent Application Publication
(10) Pub. No.: US 2005/0241596 A1
(43) Pub. Date: Nov. 3, 2005

(54) Multiple dog leash extension - a.k.a. buddie-line

(76) Inventor: Craig Walker Deverall, West Jordan, UT (US)

Correspondence Address: Craig W. Deverall, 2667 Everettwood Dr., West Jordan, UT, 84084, US

(21) Appl. No.: 11/052,506

(22) Filed: Jun. 20, 2005

Related U.S. Application Data
(60) Provisional application No. 60/544,831, filed on Feb. 17, 2004.

(51) Int. Cl. A01K 27/00

(52) U.S. Cl. 119/792

(57) ABSTRACT

This invention relates to walking more than one dog by one person with which this can be accomplished by holding one retractable leash (of any brand of leash) with my invention (Buddieline) clipped to said leash in a zip-line fashion on said leashes' retractable cord and clipping to each dog (one dog per Buddieline) while controling dogs with one retractable leash, leaving one hand free.

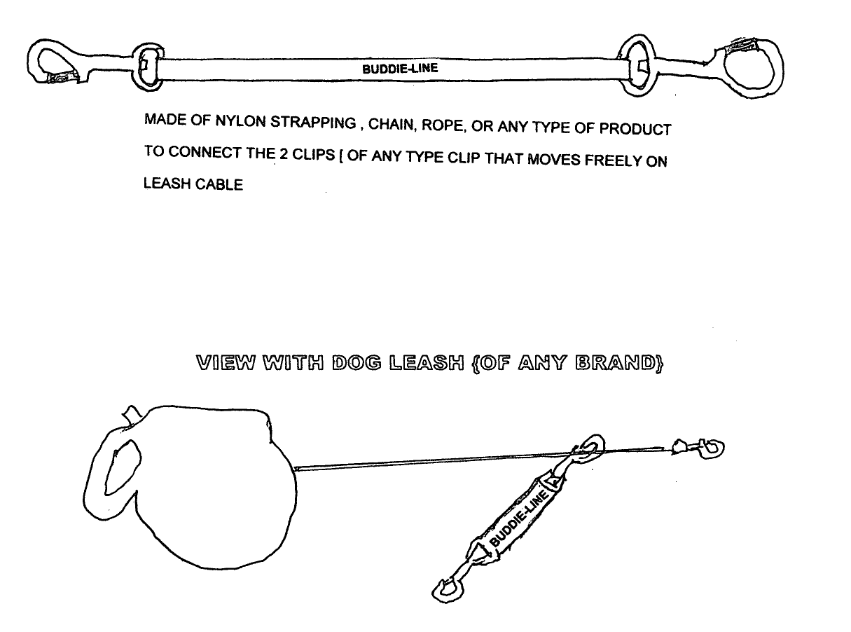

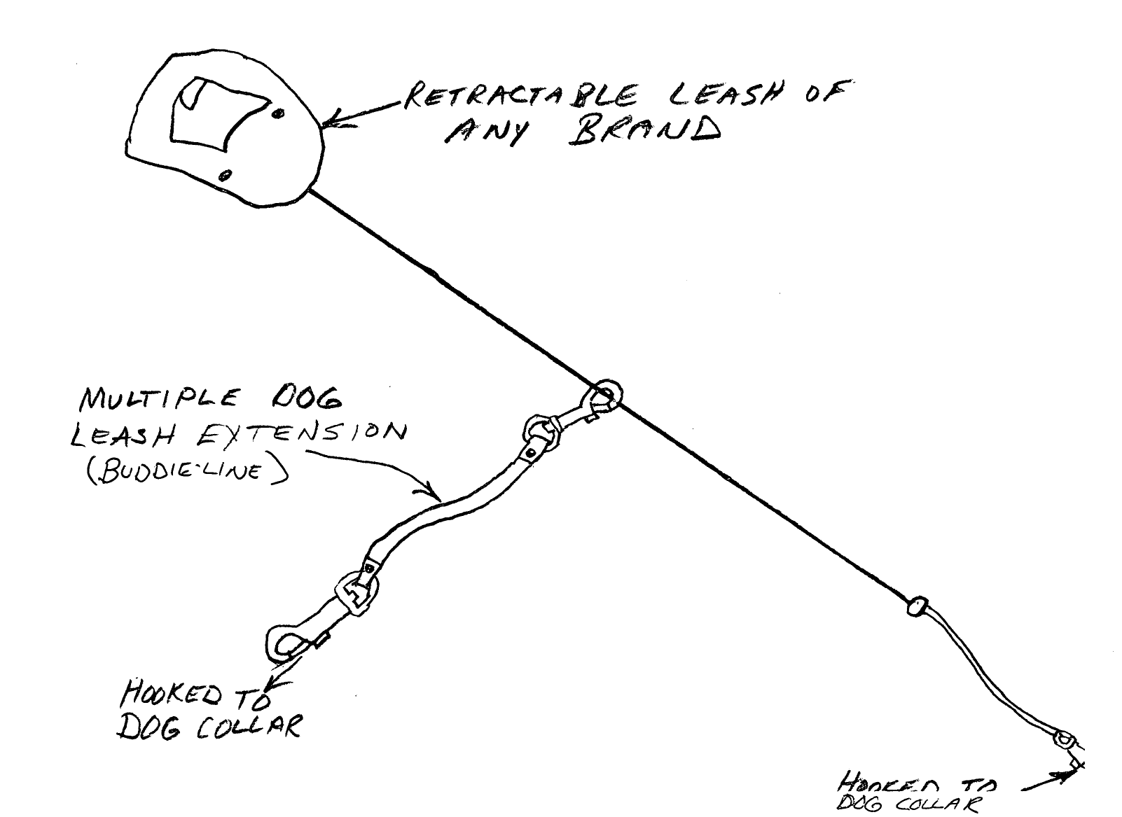

### DESCRIPTION OF THE PREFERRED EMBODIMENT

The Buddieline is made from clips [which can be of any brand of clip that locks and is made of metal] and of a piece of rope, strap, or chain, etc. where-as they are joined together, with a hook on each end, the length between is makers choice. The Buddieline is than clipped onto a retractable dog leash [of any brand of dog leash] so to have a zip-line affect.

The Multiple Dog Leash Extension a.k.a., Buddieline—is to make walking of two or more dogs more easy on handler and the dogs. The handler can walk with one free hand and the dogs can be more indepentant by being able to use zip-line affect to move along the dog leash. The old way of walking two or more dogs with one leash per dog is a tangled up mess.

1. I claim the multiple dog leash extension (Buddieline) is a better way to walk two or more dogs with the use of one retractable leash (of any brand) with my invention added to an existing retractable leash by clipping one end of Buddieline to one dog collar and then dipping other end to said leash and working in a zip-line affect (sliding on retractable leash cord with a metal clip) (of any brand of clip) on said leash cord as to walk two or more dogs with one hand on leash and leaving other hand free, and leaving dogs free movement on said leash cord without getting tangled like when using one leash per dog would get tangled.
